(19) United States
(12) Patent Application Publication
(10) Pub. No.: US 2016/0376520 A1
(43) Pub. Date: Dec. 29, 2016

(54) Continuous In-Line Process for Making Fragrance Composition

(71) Applicant: The Procter & Gamble Company, Cincinnati, OH (US)

(72) Inventors: Sarah Noelle ABSHER, Cincinnati, OH (US); William James WHITTAKER, Addlestone (GB); Anna Frances GALLOWAY, Killingworth (GB)

(21) Appl. No.: 15/189,065

(22) Filed: Jun. 22, 2016

Related U.S. Application Data
(60) Provisional application No. 62/185,719, filed on Jun. 29, 2015.

(51) Int. Cl. C11B 9/00; B01D 9/00; B01D 9/04

(52) U.S. Cl. CPC C11B 9/00; B01D 9/04; B01D 9/0059; B01D 9/0004

(57) ABSTRACT

A continuous in-line process of making fragrance compositions increases the rate of production, compared to traditional batch processes, by having a chilling step that accelerates precipitation transformation.

### FIELD OF THE INVENTION

The present invention relates to methods of making fragrance compositions on a commercial scale, specifically, continuous manufacturing methods involving a temperature mechanism for accelerating precipitation transformation.

### BACKGROUND OF THE INVENTION

A fragrance composition, such as a fine fragrance perfume, is typically made in a batch making process using vessels, such as a batch mixing tank, equipped with a standard agitator or high shear mixing device. Generally detailing a classic batch manufacturing approach, a first step has solvents (e.g., ethanol, water) and non-polar ingredients (e.g., perfume oils) added to the mixing tank per a defined recipe. As the next step, adjunct ingredients (e.g., UV stabilizers, non-perfume oil mixtures, etc.), if present, are added directly to the mixing tank. The perfume oils, used to make fragrance composition, contain high levels of natural ingredients that contain waxy carry-overs which are soluble in the perfume oils. However, mixing non-polar perfume oils with the ethanol-water solvent causes the waxes to precipitate out of solution. Precipitation in the final fragrance composition is viewed as a consumer negative and thus needs to be completely removed from the final product composition before packaging. As a result, a lengthy residence time (e.g., from 27 minutes to 1.5 hours) is typical with the classic batch making process to allow for sufficient mixing in order for complete formation of the precipitated waxes. Filtering is subsequently used to remove the undesirable wax precipitates formed during the batch making process.

There are at least several drawbacks to the above described batch process. Firstly, the typical batch making process is time-consuming and can take about 4-6 hours to produce about 1.5 tons of product. The bulk of the batch cycle is attributable to the residence time needed for mixing to precipitate the wax from solution. In addition, a “maceration” time of between 15 minutes to 90 minutes is also required with the batch making process in order to allow for the final fragrance composition to achieve the desired olfactory profile. These events can account for up to 60% of the total processing time with the batch making method. Secondly, the batch making system is inflexible by design. For example, the mixing tank size dictates the batch size. As a result, bulk production runs will tend to overproduce versus demand and additional costs are incurred to store the excess inventory before the product can be packaged and sold. Therefore, there remains a need for a fragrance composition making methodology that is capable of producing-to-demand amounts of product to minimize waste, cost, and/or time.

It is an advantage of the invention to have comparable initial quality of the end product (e.g., odor profile, visual appearance) as current batch making processes. It is a further advantage to increase the rate of production on a weight basis. It is a further advantage to minimize capital costs. It is a further advantage to reduce the manufacturing area footprint at the manufacturing site. It is a further advantage to minimize energy costs. It is a further advantage to minimize inventory of end products as well as raw materials. It is a further advantage to minimize time and materials associated with frequent changeovers (i.e., changing the formula of the fragrance composition).

### SUMMARY OF THE INVENTION

Surprisingly, applicants have discovered the lengthy precipitation transformation time associated with a classic batch process for making a fragrance composition can be accelerated by a temperature solubility mechanism, i.e., a chilling step, and preferably also a chemical solubility mechanism, in the context of a continuous in-line process.

A first aspect of the present invention is directed to a continuous in-line process for making a fragrance composition, comprising the steps of: (a) providing into a main line a pre-filtration solvent and a pre-filtration non-polar ingredient to form a pre-filtration solution; (b) mixing the pre-filtration solution to form a mixed solution streaming through the main line; (c) chilling the mixed solution to a temperature below 10° C. to provide a chilled solution containing precipitates; and (d) filtering the chilled solution containing precipitates through a filter to remove the precipitates to provide a post-filtration solution streaming through the main line to make the fragrance composition. Preferably the chilling step is conducted at a chilling residence time of greater than 0 minutes to less than 25 minutes, preferably less than 20 minutes, more preferably less than 10 minutes, alternatively from greater than 0 minutes to less than 8 minutes, or from greater than 0 minutes to less than 5 minutes, or from greater than 0 minutes to less than 3 minutes. Preferably chilling the mixed solution is to the temperature at or below 5° C., more preferably below 0° C., yet more preferably from 0° C. to −15° C., yet still more preferably from 0° C. to −10° C. Preferably the pre-filtration non-polar ingredient comprises a perfume oil. Preferably the pre-filtration solvent is provided into the main line at a rate of from 0.1 L/min to 60 L/min, preferably from 0.9 L/min to 20 L/min Preferably the pre-filtration solvent comprises an organic solvent, preferably a low molecular weight alcohol, more preferably C₁-C₅ alcohol, even more preferably selected from the group consisting of methanol, and ethanol, preferably ethanol. Preferably the filter of the filtering step has a pore size having an average diameter of from 1 μm to 12 μm, preferably from 1 μm to 10 μm, more preferably from 1 μm to 5 μm, alternatively about 3 μm.

In another aspect, a system for continuous in-line manufacturing process of a wide variety of fragrance compositions is provided which requires less capital with respect to mixing tanks, pumps and piping. The continuous in-line manufacturing process provides significant cost savings resulting from minimizing material loss/waste, and faster manufacturing.

In yet another aspect of the present invention, a fragrance composition obtained by the continuous in-line process is provided and is equivalent to the fragrance composition produced by the batch manufacturing process, particularly with no or negligible consumer noticeable differences in the initial olfactory profile.

These and other features of the present invention will become apparent to one skilled in the art upon review of the following detailed description when taken in conjunction with the appended claims.

### BRIEF DESCRIPTION OF THE DRAWINGS

While the specification concludes with claims particularly pointing out and distinctly claiming the invention, it is believed that the invention will be better understood from the following description of the accompanying figures wherein:

FIG. 1 is a flow diagram for a continuous in-line process for making fragrance composition according to the invention.

FIG. 2 is a graph illustration rate of precipitation based on temperature and chilling residence time of perfume oil 1.

FIG. 3 is a graph illustration rate of precipitation based on temperature and chilling residence time of perfume oil 2.

FIG. 4 is a graph accelerating precipitation using ethanol/water ratio of perfume oil 1.

FIG. 5 is a graph accelerating precipitation using ethanol/water ratio of perfume oil 2.

### DETAILED DESCRIPTION OF THE INVENTION

### Definition

As used in herein, the articles “a”, “an”, and “the” mean “one or more.”

As used herein, any of the terms “comprising”, “having”, “containing”, and “including” means that other parts, steps, etc. which do not adversely affect the end result can be added. Each of these terms encompasses the terms “consisting of” and “consisting essentially of”. Unless otherwise specifically stated, the elements and/or equipment herein are believed to be widely available from multiple suppliers and sources around the world.

As used herein, the term “continuous in-line process” means a process wherein all steps occur continuously, typically simultaneously once steady state is reached, without a waiting and/or holding time between steps. This is in contrast to a batch process.

As used herein, the term “fragrance composition” refers to a product composition intended for application to a body surface, such as for example, skin or hair, i.e., to impart a desirable odor thereto, or cover a malodor thereof. These product compositions are generally in the form of perfume concentrates, perfumes, eau de parfums, eau de toilettes, aftershaves, colognes, body splashes, body sprays, or the like. The term “fragrance composition” may include a raw material for subsequent incorporation into any consumer product (e.g., beauty care product or laundry care product and the like). Various consumer products are described at www.pg.com and related websites of Applicant.

As used herein, the terms “mixing” and “blending” interchangeably refer to combining and further achieving a relatively greater degree of homogeneity thereafter.

As used herein, the term “odor profile” is a result of the combination of the so-called top, middle and base notes, if present, of a fragrance composition. An odor profile is composed of 2 characteristics: ‘intensity’ and ‘character’. The ‘intensity’ relates to the perceived strength whilst ‘character’ refers to the odor impression or quality of the perfume (i.e., fruity, floral, woody, etc.).

As used herein, the words “preferred”, “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein “UV absorber” are those chemicals that are suitable for inclusion in fragrance composition that will absorb harmful ultraviolet radiation that may otherwise cause undesirable reactions in perfume raw materials contained in the fine fragrance composition. Preferably the UV absorber will absorb either UV-A (320-400 nm) or UV-B (280-320 nm) ranges, more preferably both UV-A and UV-B ranges. UV absorbers may be either oil-soluble or water-soluble. UVINUL® is a trade name (BASF) of a number of UV absorbers. A non-limiting list includes: 2,2-Dihydroxy-4,4-dimethoxybenzophenone-5,5-disodium sulfonate (UVINUL® DS 49); 2-(4-Diethylamino-2-hydroxybenzoyl)-benzoic acid hexylester (UVINUL® A Plus); 2,4,6-Trianilino-p-(carbo-2′-ethyl-hexyl-1-oxi)-1,3,5-triazin (UVINUL® T 150); 2-Hydroxy-4-methoxybenzophenone (UVINUL® M 40); p-Methoxycinnamic acid 2-ethylhexyl ester (UVINUL® MC 80 (N)); 2-Cyano-3,3-diphenylacrylic acid 2′-ethylhexyl ester (UVINUL® N 539 T); 4-Bis(polyethoxy)para-aminobenzoic acid polyethoxyethyl ester (UVINUL® P 25); 2-Hydroxy-4-methoxybenzophenone-5-sulfonic acid (UVINUL® MS 40). The concentration of a

UV absorber is typically about 0.01 to 1%, preferably from 0.05 to 0.5% by weight of the final fragrance composition. Further information is available from BASF and their publication MEMC 050103e-2 Jun. 2006 publication.

All percentages, parts and ratios are based upon the total weight of the fragrance composition, unless otherwise specified. All such weights as they pertain to listed ingredients are based on the active level and, therefore do not include carriers or by-products that may be included in commercially available materials. The components, including those which may optionally be added, as well as methods for preparation, and methods for use, are described in detail below.

All ratios are weight ratios unless specifically stated otherwise. All temperatures are in Celsius degrees (° C.), unless specifically stated otherwise. All measurements referred to herein are made at about 25° C., i.e., room temperature conditions, unless otherwise specified. Continuous In-Line Process

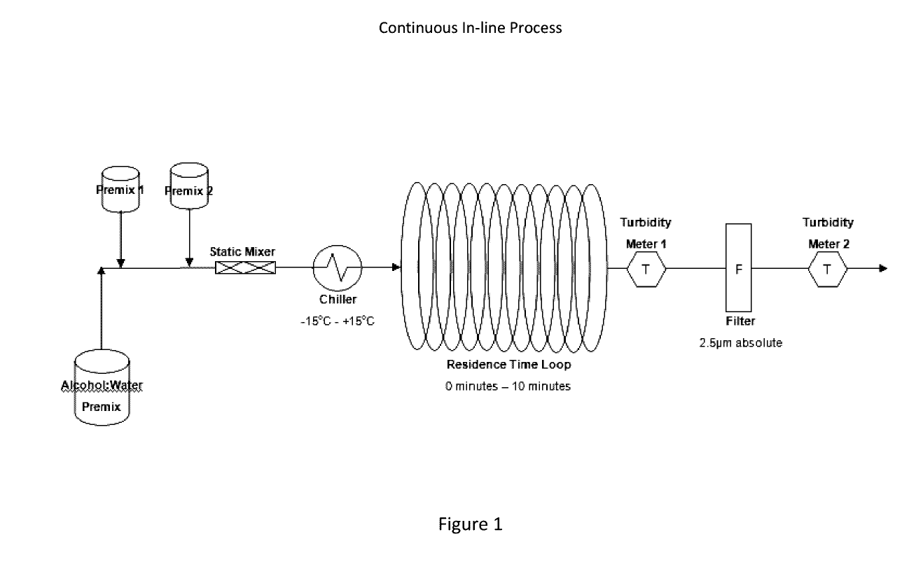

FIG. 1 depicts a continuous in-line process of the present invention. The present invention changes fragrance composition making from a batch making process to a continuous in-line process, i.e., comprising multiple ingredient streams. Specifically, the present invention addresses manufacturing flexibility issues involved in making fragrance compositions to demand without compromising fragrance composition initial quality in terms of odor profile and/or visual appearance. The present continuous in-line process also provides faster variant (i.e., formulation changes) turnaround times, shorter clean-up times between variants, and/or significant material waste reduction than those of the classic batch making process. Moreover, the present invention allows a high degree of fragrance composition customization, minimizing the need of dedicated storage vessels for different finished products which otherwise would need to be stored before the packing operation.

The foregoing benefits are possible, in part, due to the reduction of the lengthy residence time typically needed in the classic batch making process for mixing the pre-filtration solvent and a pre-filtration non-polar ingredient to form precipitates (e.g., precipitated waxes), which tends to take up the majority of the batch cycle time. However, the reduction of the residence time from the continuous in-line process will have the undesirable consequence of limiting and/or preventing the necessary precipitation of the waxes out of solution. Surprisingly, the applicants have discovered that the precipitation reaction can be accelerated by a temperature solubility mechanism (i.e., a chilling step), and preferably an additional chemical solubility mechanism. In particularly, it is possible to accelerate the precipitation reaction by chilling the mixed solution (e.g., of solvent and perfume oil) to accelerate the precipitation transformation. Without wishing to be bound by theory, the lower the temperature of a solvent, the less soluble are solutes dissolved therein. Still further, it is possible to further accelerate the precipitation reaction by adding solvent at different points along a main line in the in-line process to influence the polarity of the system streaming therein. For example, if the solvent is an aqueous-alcohol solvent, the polarity of the system can be modified at different points along the main-line by providing solvent having different weight ratios of the aqueous:alcohol solvent. More relative water, the more polar is the solvent and thus the system. More relative alcohol, the more non-polar is the solvent and thus the system. Accordingly a more polar streaming system is able to accelerate precipitation transformation of non-polar waxy precipitates as compared to a more non-polar streaming system. The polarity of the system downstream is subsequently decreased by adding more alcohol into the main line after the step of filtering precipitates. Alternatively, the total amount of the solvent, with respect to the final fragrance composition, can be divided so that it can be added at two, three, four, five or more locations along the main line for the continuous in-line process. This changes the ratio of the solvent:perfume oil (i.e., solvent to solute) in the streaming system. Generally, and without wishing to be bound theory, the greater that ratio of solvent to solute, the greater is the solubility of the solute therein. The amounts of the solvent, to be added at the different locations along the main line, may be the same or different. The polarity of the solvent, to be added at the different locations along the main line, may be the same or different.

The final fragrance composition may comprise from 50 wt % to 99 wt % or from 75 wt % to 95 wt % by weight of the total fragrance composition of solvent. The solvent may be an aqueous-alcohol solvent.

In one aspect, the solvent is added at different points or locations in the continuous in-line process for making a fragrance composition. For example, “pre-filtration solvent” means any solvent that is provided before the filtration step of the continuous in-line process herein. There could be one or more pre-filtration solvents that are provided into the main line (e.g., a first pre-filtration solvent, a second pre-filtration solvent, etc.). In those embodiments where more than one pre-filtration solvent is used, these solvents may or may not be the same composition. As used herein, the term “post-filtration solvent” means any solvent that is provided after the filtration step of the continuous in-line process herein (even if additional filtration steps are employed downstream of the initial filtration step). There could be one or more post-filtration solvents that are provided into the main line (e.g., a first post-filtration solvent, a second post-filtration solvent, etc.). In those embodiments where more than one post-filtration solvent is used, these solvents may or may not be the same composition, and may or may not be the same composition relative to pre-filtration solvent(s). One example of a post-filtration solvent is an aqueous-alcohol solvent. Another example of a post-filtration solvent is ethanol.

Suitable examples of solvent (either pre-filtration or post-filtration) include water and organic solvents such as a low molecular weight alcohol (e.g., C₁-C₁₀), more preferably C₁-C₅ alcohol, such as methanol and ethanol, preferably ethanol. Examples of a suitable ethanol include: denatured ethanol from a fermented or distillation process from commercially available suppliers ALCODIS (Brussels, BE), Bundesmonopolverwaltung (Offenbach DE), France Alcools (Paris FR), Ineos Europe Ltd. (Grangemouth, UK), SDA BRABANT (Saint Benoite—FR), either from natural feed stocks (i.e., sugars, starch, or cellulose) or synthetic feed stocks. Preferably solvent contains ethanol, more preferably the ethanol may be a denatured or a diluted mixture of ethanol and water, which may include denaturants. Preferably, the final fragrance composition herein comprises from 47 wt % to 78 wt % by weight of the total fragrance composition of ethanol, and more preferably from 47 wt % to 73 wt %.

Preferably the pre-filtration solvent (or pre-filtration solvents collectively) is/are more polar than the post-filtration solvent (or post-filtration solvents collectively).

Preferably the post-filtration solvent (or post-filtration solvents collectively) contain(s) more alcohol on a weight by weight basis than the pre-filtration solvent (or pre-filtration solvents collectively).

Preferably the pre-filtration solvent (or pre-filtration solvents collectively) and post-filtration solvent (or post-filtration solvents collectively) both contain ethanol, wherein the post-filtration solvent (or post-filtration solvents collectively) contain(s) more ethanol on a weight by weight basis than the pre-filtration solvent (or pre-filtration solvents collectively).

While the above discussion is based on ethanol solvent for purposes of illustration only, it is intended that this approach can be applied by one skilled in the art to other organic solvents, preferably to those solvents having a polarity less than water but nevertheless soluble in water.

While not wishing to be bound by theory, it is believed that when the solvent system comprises an organic solvent and water, by lowering the levels of the organic solvent added prior to the filtering step; the water concentration is thereby increased to give a reduction in the amount of the organic solvent to water. Waxes tend to be more chemically insoluble in water versus ethanol given water's higher polarity. As a result, the reduction of ethanol solvent levels during the chilling step results in acceleration of the precipitation transformation (e.g., wax precipitation) out of solution. The balance of the ethanol solvents can then be added post the filtering step to complete the recipe of the final fragrance composition.

The continuous in-line process provides into a main line (e.g., via a liquid injection system) a pre-filtration solvent and a pre-filtration non-polar ingredient, preferably in liquid form, to form a pre-filtration solution in the main line. In an embodiment, the pre-filtration solvent is injected into the main line at a rate of 0.1 L/min to 60 L/min, preferably from 0.9 L/min to 20 L/min, more preferably from 5 L/min to 18 L/min, alternatively from 16 L/min to 18 L/min The liquid injection system allows for addition at the same time or sequential addition of these ingredients into the main line to produce a pre-filtration solution in the main line.

The pre-filtration solvent comprises one or more organic solvents including alcohols, preferably low molecular weight alcohols, preferably C₁ to C₁₀ alcohols, more preferably C₁ to C₅ alcohols, even more preferably methanol and ethanol, and most preferably ethanol. Preferably the pre-filtration solvent comprises water. The water may be provided before the alcohol(s) into the main line or the alcohol(s) may be provided before the water into the main line or preferably the water and alcohols may be added into the main line at the same time. Preferably the water and alcohols may be provided as a pre-mixture (i.e., aqueous-alcohol) as the pre-filtration solvent into the main line. The pre-mixture is formed by separately combining the water and alcohol(s) (before addition to the main line).

A step in the continuous in-line process that provides a pre-filtration non-polar ingredient into a main line. One such example is perfume oil. The process may have multiple perfume oils each contained in its own respective perfume oil holding tank, wherein each of said perfume tanks may hold its own fragrance composition and have its own respective perfume line in fluid communication with the main line; or multiple perfume tanks each sharing a single perfume line in fluid communication to the main line; or combinations thereof. Alternatively, the fragrance composition holding tank is in fluid communication to a plurality of perfume raw material containers holding perfume raw materials that can be metered individually into the fragrance composition tank to provide unique or customizable fragrance compositions.

Optionally, one or more adjunct materials are contained in one or more adjunct holding tanks containing one or more respective adjunct materials. These adjunct ingredients are provided into the main line by: (i) one or more respective adjunct material lines that are in fluid communication from the adjunct material holding tank(s) to the main line; or (ii) wherein the adjunct material line is in fluid communication with the perfume line (and thus added to the main line via the perfume line); or (iii) the one or more adjunct lines are in fluid communication with the perfume holding tank and wherein the adjunct(s) are added to the main line via the perfume holding tank and respective perfume line; or (iv) combinations thereof.

Preferably the adjunct materials are provided into the main line after step where the pre-filtration solvent and pre-filtration non-polar ingredient have been provided into the main line but before the mixing step. In one embodiment, the adjunct material(s) are selected from the group consisting of: (a) an oil-based pre-mixture, (b) a non-oil based pre-mixture, and (c) mixtures thereof. The oil-based pre-mixture, in turn, is selected from one or more ingredients consisting of a UV stabilizer, a skin active, a solubilizer, and combinations thereof. The non-oil based pre-mixture, in turn, is selected from one or more ingredients consisting of a chelating agent, a skin conditioning agent, a cyclodextrin, a pH buffering system, a perfume longevity agent, and combinations thereof.

The continuous in-line process comprises a further step mixing the pre-filtration solution, and adjunct materials if present, in a mixer, in upstream proximity to a filter to form a mixed solution streaming through the main line. The mixing step subjects the pre-filtration solution to enough mixing energy to produce a mixed solution of uniform dispersion. The mixed solution may or may not contain precipitates (e.g., precipitation of the waxes from the perfume oils). The residence time for the mixing step for the continuous in-line process versus the batch making process is greatly reduced. For example, suitable residence time for the mixing step of the present invention is from greater than 0 min to 10 mins, preferably from 0.1 sec to 2 minutes or more preferably less than 1 second.

A step in the continuous in-line process of the present invention is chilling the mixed solution to a temperature below 10° C. to provide a chilled solution containing precipitates. Preferably the temperature is below 5° C., more preferably at or below 0° C., yet more preferably from 0° C. to −15° C., yet still more preferably from 0° C. to −10° C. Preferably the chilling step further comprises the use of a heat exchanger configured to remove heat from mixed solution streaming through the main line. The chilling residence time is from greater than 0 minute to less than 25 minutes, preferably less than 20 minutes, more preferably less than 10 minutes, alternatively from greater than 0 minutes to less than 8 minutes, or greater than 0 minutes to less than 5 minutes, or greater than 0 minutes to less than 3 minutes. The chilling residence time can be varied, for example, by flow rate of the system streaming through main-line; and the diameter and length of the main-line through the heat exchanger. One way to save space while increasing chilling residence time is to make a number loops or coils in the main-line.

The process may include the optional step of metering turbidity of the chilled solution containing precipitates with a turbidity meter (with the objective of quantifying the amount precipitates) after the chilling step but before the filtering step.

The process comprises the step of filtering the chilled solution containing precipitates through a filter to remove the precipitates to provide a post-filtration solution.

The filtering step is accomplished by streaming the chilled solution through one or more filters to provide a post-filtration solution. Non-limiting examples of suitable filters include a lenticular filter or a cartridge filter. Preferably the filter has a pore size having an average diameter of from 1 μm to 10 μm, preferably between 1 μm to 3 μm, or alternatively between 2 μm to 3 μm. A non-limiting example of a suitable cartridge filter is one commercially available from PALL Profile Star polypropylene Filter, 3.0 μm KA3A030P1, or Carlson Lenticular cellulose Filters, ID XE50H, LC 1216G.

The process may include the optional step of metering turbidity of the post-filtration solution with a turbidity meter (with the objective of quantifying the amount precipitates, if any) after filtering step. The results of the metered turbidity of the chilled solution can be compared to that of the metered turbidity of the filter solution (to see how effective the filtering is in removing the precipitates). The results can also be used as a quality control check in the process of making the fragrance compositions.

The continuous in-line process may further comprise the step adding a post-filtration solvent into the main line to the filtered solution to make the fragrance composition. Post-filtration solvents are described above. Preferably the post-filtration solvent comprises ethanol.

The continuous in-line process may further comprise the step of mixing the post-filtration solution (with or without the addition of post-filtration solvent) to make the fragrance composition (i.e., a second mixing step). The mixing step subjects the post-filtration solution to enough mixing energy to produce a mixed solution of uniform dispersion. Suitable residence time for this second mixing step is from greater than 0 minute to 10 minutes, preferably from 0.1 sec to 2 minutes, or more preferably less than 1 second.

Preferably the mixers in the inventive process herein are static mixers. An example of a suitable static mixer is one commercially available from Lotus Mixers, Inc. (Nokomis Fla.) under the product name “SL static mixer”, or from Sulzer Ltd., under the product name “Static Mixer Type SMX”.

In an embodiment, the continuous in-line process may comprise a further step of providing into the main line a post-filtration non-polar ingredient to the post-filtration solution. Non-limiting examples of a suitable post-filtration non-polar ingredient includes a dye solution for aesthetic purposes, wherein the dye solution is selected from the group consisting of: dyes, colorants, and mixtures thereof. This addition may be before a third mixing step or before a second mixing step. Any dyes and colorants total less than 2 wt % of the final fragrance composition, preferably less than 1 wt %.

Other aspect of the present invention provides for a continuous in-line process of making a fragrance composition comprising the steps of: providing into a main line a pre-filtration solvent and a pre-filtration non-polar ingredient to form a pre-filtration solution, wherein the pre-filtration non-polar ingredient comprises a perfume oil and the pre-filtration solvent comprises from 40% to 100% ethanol by weight of the pre-filtration solvent, and the pre-filtration solvent is provided into the main line at a rate from 0.9 L/min to 20 L/min Another step is mixing the pre-filtration solution to form a mixed solution streaming through the main line. Another step is chilling the mixed solution to a temperature 5° C. to −15° C. to provide a chilled solution containing precipitates, and wherein the step of reducing the temperature is conducted at a chilling residence time from greater than 0 minutes to less than 10 minutes. Another step is filtering the chilled solution containing precipitates through a filter to remove the precipitates to provide a post-filtration solution streaming through the main line to make the fragrance composition, wherein the filter having a pore size having an average diameter of from 1 μm to 10 μm to provide a filtered solution streaming through the main line. Another step is adding a post-filtration solvent into the main line to the filtered solution to make the fragrance composition, wherein the post-filtration solvent comprises ethanol. The process results in the fragrance composition having from 0.1 wt % to 40 wt % of perfume oil, from 10 wt % to 80 wt % of ethanol, and an optional ingredient, wherein the wt % is relative to the total weight of the fragrance composition. The term “optional ingredient” is used broadly herein to mean any other ingredients or components in the fragrance composition that make up the balance of the fragrance composition to make up 100 wt %. Non-limiting examples of optional ingredients may include previously defined adjunct ingredients.

Acceptable amounts of finished product or intermediate fragrance compositions can be re-mixed in the continuous in-line process. This allows for a reduction and/or elimination of costs linked to disposal and/or scrap of these compositions, which are obtained by planned or unplanned manufacturing operations. For example, products which could either not have been shipped to the market according to internal manufacturing guidelines or returned from the trade after having been previously shipped.

### Perfume Oils

In an embodiment of the present invention, the pre-filtration non-polar ingredient is preferably “perfume oils” and which relates to a perfume raw material, or a mixture of perfume raw materials, that are used to impart an overall pleasant odor or fragrance profile to a composition. Perfume oils can encompass any suitable perfume raw materials for fragrance uses, including materials such as, for example, alcohols, aldehydes, ketones, esters, ethers, acetates, nitriles, terpene hydrocarbons, nitrogenous or sulfurous heterocyclic compounds and essential oils. However, naturally occurring plant and animal oils and exudates comprising complex mixtures of various chemical components are also know for use as fragrance materials and are included within the meaning of “perfume oils.” The individual perfume raw materials which comprise a known natural perfume oil can be found by reference to Journals commonly used by those skilled in the art such as “Perfume and Flavourist” or “Journal of Essential Oil Research”, or listed in reference texts such as the book by S. Arctander, Perfume and Flavor Chemicals, 1969, Montclair, N.J., USA and more recently re-published by Allured Publishing Corporation Illinois (1994).

Additionally, some perfume raw materials are supplied by the fragrance houses (Firmenich, International Flavors & Fragrances (“IFF”), Givaudan, Symrise) as mixtures in the form of proprietary specialty accords. Non-limiting examples of the fragrance materials useful herein include pro-fragrances such as acetal pro-fragrances, ketal pro-fragrances, ester pro-fragrances, hydrolyzable inorganic-organic pro-fragrances, and mixtures thereof. The fragrance materials may be released from the pro-fragrances in a number of ways. For example, the fragrance may be released as a result of simple hydrolysis, or by a shift in an equilibrium reaction, or by a pH-change, or by enzymatic release.

Preferably, the fragrance compositions herein comprises from 0.1 wt % to 40 wt % by weight of the total fragrance composition of a perfume oil or a mixture thereof, more preferably from 2.5 wt % to 25 wt %, and most preferably from 2.5 wt % to 20 wt %. The remaining amount wt % of the fragrance composition (to total 100 wt %) is attributable to solvent(s) or adjunct ingredients.

Non-limiting examples of fragrance composition resulting from the continuous in-line process according to the present invention are selected from the group consisting of a perfume, a fine fragrance perfume, an eau de toilette, an eau de partum, a cologne, a body splash or a body spray. Alternatively the fragrance composition can be added as an ingredient to a household care or personal care composition.

### EXAMPLES

The following examples are provided to further illustrate the present invention and are not to be construed as limitations of the present invention, as many variations of the present invention are possible without departing from its spirit or scope.

### Example 1

### Continuous In-Line Process for Making Fragrance Compositions

Referencing the schematic of FIG. 1, fragrance compositions are made by providing in a main line a pre-filtration solvent and a pre-filtration non-polar ingredient to provide a pre-filtration solution. In this non-limiting example, the pre-filtration solvent is an ethanol and water solvent that is provided at two different ethanol:water weight ratios, namely 6.5:1 and 4.16:1, respectively. To drive an increase in the formation of precipitates, generally a lower amount of ethanol can be used. However, if the level of ethanol is too low, then the temperature at the chilling step, partial freezing (e.g., ice crystal formation) may happen at temperature below 0° C. Therefore, high ethanol ratios are considered when temperatures below 0° C. are employed (e.g., −15° C.) during the chilling step. The pre-filtration solvent, at the desired ethanol and water ratio, can be pre-mixed in a 55 gallon drum and be injected into the main line.

As illustrated in FIG. 1, pre-filtration non-polar ingredient having perfume oil and optionally UVINUL® branded UV absorbers. The pre-filtration non-polar ingredients can be pre-mixed and then injected into the main line downstream from the pre-filtration solvent.

Further downstream from the pre-filtration non-polar ingredients, non-oil soluble materials can be pre-mixed with a solvent and then injected into the main line. These non-oil soluble materials may include cyclodextrin, EDTA, allatoin, lactic acid, and sodium hydroxide.

The main line is a pipe having a diameter of 6 mm, and ingredients are added into main line through a side stream, such as for example, a T-junction through a 3 mm pipe. The side stream can be equipped with a pump and a flow meter to ensure that the correct amounts of ingredients/materials are dosed into the main line.

Mixing, the pre-filtration solution to form a mixed solution streaming through the main line is through a static mixer in the main line. For example, the static mixer can be 6 mm in diameter, SMX or Helical configuration, and 10-12 elements in length). The mixing residence time, through the static mixer, is approximately one second or less than 1 second. Although not implemented here, more than one mixer or static mixer may be used.

The mixed solution is chilled to provide a chilled solution containing precipitates. The temperature is selected either −15° C. or 0° C. The chilling residence time is either 2 minutes or 27 minutes. The time can be shorted and extend, in part, due the length of the pipe (e.g., the number of coils in main line) during the chilling step. See FIG. 1.

The filter in the filter step has a 3 μm pore size. The filter may be a cartridge filter or a ventricular filter. Although not implemented here, more than one filter may be used.

A first turbidity meter is installed immediately upstream the filter. A second turbidity meter is installed immediately downstream the filter. A non-limiting example of a turbidity meter is The Kemtrak TC007 Industrial Turbidimeter™ (Sweden), which is an in-line (or off-line) fiber optic turbidimeter designed to measure the concentration of light scattering components for a wide range of industrial process applications. The TC007™ measures attenuated light and/or scattered light which is mathematically combined using a ratio algorithm to accurately monitor the turbidity of a sample. Turbidity is measured as NTU (Number of Turbid Units).

### Example 2

### Rate of Precipitation Based on Temperature and Chilling Time

Perfume oil 1 and perfume oil 2 are assessed for their rate of precipitation based on temperature and chilling residence time using lab scale continuous in-line process conditions. Perfume oil 1 is ETHNIC ICE PG 172227 G supplied by Firmenich SA. Perfume oil 2 is Acadia 253 RF 42 supplied by Givaudan. Perfume oil 1 is made into a first final fragrance composition and perfume oil 2 is made into a second final fragrance composition, each comprising at or slightly less than 10% by weight of the respective final fragrance compositions. Both fragrance compositions contain ethanol and water.

In this experiment, both perfume oils have the ethanol:water weight ratio is at 6.5:1 respectively. In other words, the mixed solution contains: 10% perfume oil, 78% ethanol, and 12% water, by weight of the mixed solution.

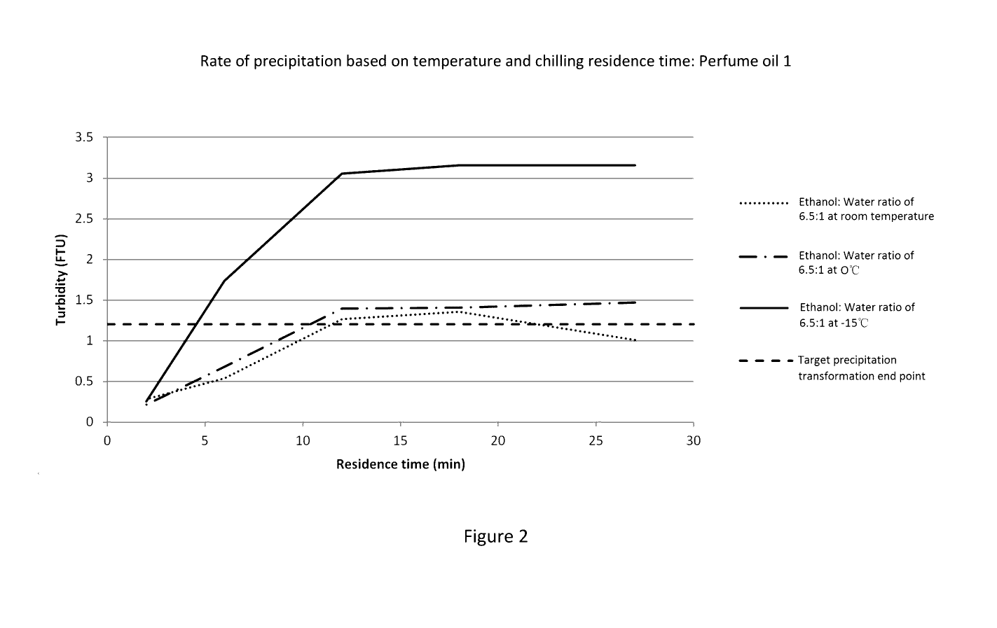

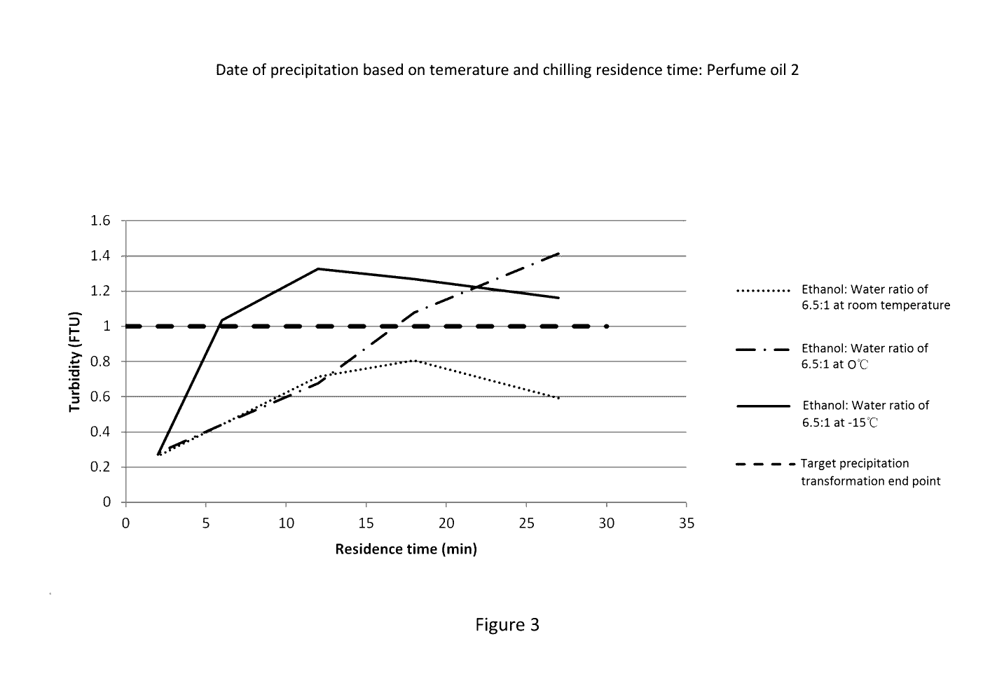

The graphs of FIGS. 2 and 3 reflect the results of the studies for perfume oil 1 and perfume oil 2, respectively. These experiments indicate that the rate of precipitation can be significantly accelerated through the reduction in process temperature to −15° C. Although the data is not shown here, the “target precipitation transformation end point” indicated in these graphs is the precipitation measured in earlier classic batch manufacturing process. Based on the two perfume oils tested, there is a suggestion that the target precipitation transformation end point (measured by turbidity) can be achieved at −15° C. with a chilling residence time of 4 to 6 minutes. Both graphs demonstrate a higher initial rate of formation of precipitation at −15° C.

The effect is greater for perfume oil 1 where the time required to reach target turbidity (i.e., precipitation) is around 4 minutes when processed at −15° C., compared with 12 minutes at higher temperatures. For perfume oil 2 the time required to reach target turbidity is around 5-6 minutes.

### Example 3

### Accelerating Precipitation Using Ethanol/Water Ratio

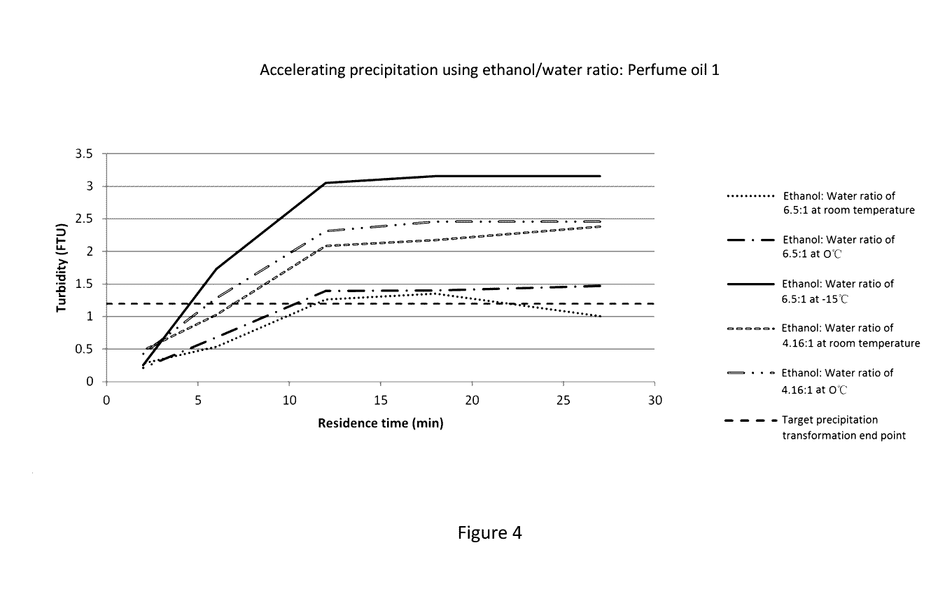

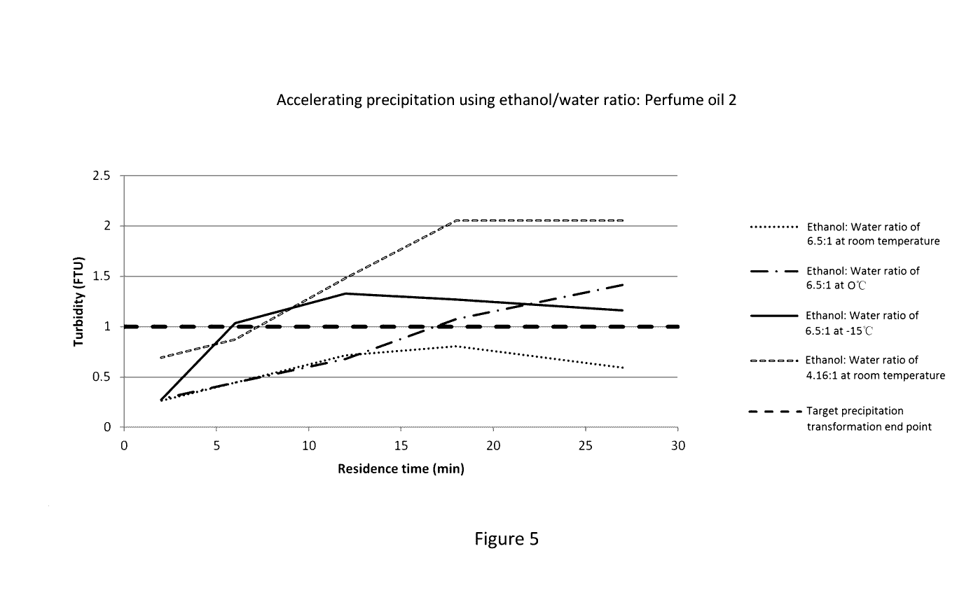

The effectiveness of accelerating precipitation using different ethanol:water weight ratios is explored with perfume oil 1 and perfume oil 2. Results are presented in the graphs of FIGS. 4 and 5, respectively. Reducing the weight ratio of ethanol to water when forming a mixed solution (i.e., perfume oil solubilization) and chilled solution containing precipitates (i.e., precipitation transformations) results in an increase in precipitation formation; however, this solvent effect is of a lower magnitude compared to reducing chilling temperature.

A mixed solution containing an ethanol:water weight ratio of either 6.5:1 or 4.16:1 are investigated. The mixed solution contains an ethanol:water weight ratio of 6.5:1 is described in earlier Example 2. An ethanol:water weight ratio in the mixed solution of 4.16:1 is obtained by providing 10% perfume oil; 50% ethanol; and 12% water by weight of the mixed solution. Flow rates between the two ethanol-water ratios experiments are held constant (so only effects attributed to the differences in ethanol weight ratio is observed). Experiments are carried out using a lower weight ratio of ethanol:water to understand whether reducing the solubility of the perfume oil will drive an increase precipitate formation (e.g., formation of perfume oil insolubles). Although not described further herein, in practice the remaining ethanol (or other alcohol) that is needed to complete the final fragrance composition formulation may be added into the mainline downstream of the filtration step.

It is observed that reducing the chilling temperature below 0° C. is not feasible with an ethanol weight ratio reduced to 4.16:1 due to ice crystal formation. It is possible that higher ratios (e.g. 5:1) could be considered if combining with low temperature levers (e.g. −15° C.). Turning to the graph of FIG. 4, decreased ethanol weight ratio at both room temperature and chilling temperature of 0° C. has a similar effect on precipitation formation. Initial turbidity, turbidity rate and final turbidity were all increased although the impact was not as great as reducing temperature. Experiments with perfume oil 1, as illustrated in the graph of FIG. 4, indicate that the impact of reducing temperature with decreased ethanol weight ratio is minimal. Initial turbidity (at 2 minutes) and final turbidity is significantly higher than with reduced temperature experiments indicating that a greater number of precipitates can be driven from solution by reducing the ethanol weight ratio; however the initial rate of dissolution is still lower than with the −15° C. experiments indicating that low temperature is a greater driving force for precipitation to reach the target precipitation level.

### Example 4

### Odor Profile Assessment

The odor profile, for final fragrance compositions made on the continuous in-line process herein described, are evaluated. Fragrance compositions (containing perfume oil 1 and perfume oil 2) are made according to the continuous in-line process as described in Example 1 and at the indicated conditions (i.e., of chilling temperature and ethanol:water solvent ratio) of Table 2a and 2b below.

The odor profile evaluation method is described. Panelists assess the odor profile of the fragrance compositions as described in Table 2a and 2b below. Panelists are selected from individuals who are either trained to evaluate odor profile according to the scales below or who have experience of fragrance evaluation in the industry.

Odor profile for each fragrance composition is evaluated immediately after production. Evaluation is performed by the panelists using smelling strips (i.e., thin paper blotters). The paper blotter is immersed approximately 2 cm into the test fragrance composition. The panelists are then asked to evaluate the odor profile at two characteristic time points for each sample:

(i) Top Note: Odor profile evaluated within 5 minutes after immersing the paper blotter into the fragrance composition.

(ii) Dry Down: Odor profile evaluated after the volatile components have evaporated (i.e., base notes of the fragrance). Typically, this is evaluated at about 1-2 hours after the blotter has been dipped into the fragrance composition and allowed to air dry at room temperature.

For each time point, the panelists are asked to give a score of 1 to 5 for odor profile according to the odor score scale set out in Table 1 herein below. The odor performance is evaluated on a 5-point scale versus an odor standard (described further below). Evaluation criteria are as follows:

(i) Evaluation scores of 1, 2 and 3 pass odor evaluation versus the standard;

(ii) Evaluation scores of 4 and 5 do not pass odor evaluation versus standard.

TABLE 1
Odor Evaluation Scale for Fragrance Compositions

| Odor Score | Evaluation Description |
|---|---|
| 1 | Perfume unchanged - no difference versus standard |
| 1a | Perfume weaker but character unchanged |
| 1b | Perfume stronger but character unchanged |
| 2 | Slight change - only noticeable when compared directly |
| | with standard; consumer acceptable |
| 3 | Noticeable change but of similar character to standard; |
| | consumer acceptable |
| 4 | Large difference in perfume character; consumer noticeable |
| | (i.e., unacceptable versus standard) |
| 5 | Total difference in perfume character (i.e., unacceptable |
| | versus standard) |

A panel of 4 or 5 panelists evaluated the odor profile of each fragrance composition at initial time 0 (i.e., freshly processed fragrance composition). At each of the indicated conditions, the odor profile of the subject fragrance composition made on the continuous in-line process is evaluated against the odor standard which is the relevant fragrance composition made by the continuous in-line process at 27 min residence time, filtered at 0° C. experiment (since this is the closest to classic batch process conditions). The results are provided in Tables 2a and 2b herein below.

Tables 2a and 2b: Initial Odor of first and second fragrance compositions made in a continuous in-line process at various conditions of ethanol:water weight ratio and chilling temperature.

TABLE 2a

| | Conditions | | 27 min residence time | | 27 min residence time | |
|---|---|---|---|---|---|---|
| | | Chill- | No filtering | | Filtered | |
| Perfume | Weight | ing | Top | Dry | Top | Dry |
| Oil: | Ratio^{C} | ° C.^{D} | Note | Down | Note | Down |
| Perfume | 6.5 | 25 | 2 | 2 | 2 | 2 |
| 1^{A} | 6.5 | 0 | 2 | 2 | Standard | Standard |
| | 6.5 | −15 | 3 | 2 | 3 | 3 |
| | 4.16 | 25 | 2 | 2 | 3 | 2 |
| | 4.16 | 0 | 2 | 2 | 3 | 2 |
| Perfume | 6.5 | 25 | 3 | 2 | 2 | 2 |
| 2^{B} | 6.5 | 0 | 2 | 2 | Standard | Standard |
| | 6.5 | −15 | 3 | 3 | 2 | 2 |
| | 4.16 | 25 | 3 | 2 | 2 | 2 |

TABLE 2b

| | Conditions | | 2 min residence time | | 2 min residence time | |
|---|---|---|---|---|---|---|
| | | Chill- | No filtering | | Filtered | |
| Perfume | Weight | ing | Top | Dry | Top | Dry |
| Oil: | Ratio^{C} | ° C.^{D} | Note | Down | Note | Down |
| Perfume | 6.5 | 25 | 2 | 2 | 3 | 2 |
| 1^{A} | 6.5 | 0 | 3 | 2 | 2 | 2 |
| | 6.5 | −15 | 2 | 2 | 3 | 3 |
| | 4.16 | 25 | 2 | 2 | 2 | 2 |
| | 4.16 | 0 | 3 | 2 | 3 | 2 |
| Perfume | 6.5 | 25 | 3 | 2 | 3 | 2 |
| 2^{B} | 6.5 | 0 | 3 | 2 | 3 | 2 |
| | 6.5 | −15 | 2 | 2 | 3 | 3 |
| | 4.16 | 25 | 2 | 3 | 3 | 2 |

^{A}Perfume oil 1 is ETHNIC ICE PG 172227 G supplied by Firmenich SA.
^{B}Perfume oil 2 is Acadia 253 RF 42 supplied by Givaudan.
^{C}Weight ratio of ethanol:water in the mixed solution.
^{D}Temperature achieved during chilling step. For purposes of clarification, a chilling temperature of 25° C. indicates that no chilling of the mixed solution was actually conducted.

Odour scores for products manufactured on the continuous in-in process under different process temperature conditions and residence times are assessed by fragrance odour panel. All odour results meet success criteria—i.e., a score less than or equal to 3. This indicates that initial odour is not significantly impacted by removal of precipitates (i.e., insolubles) in the filtering process, even with significantly higher turbidity before filtering (e.g. −15° C., 27 minutes). This confirms expert perfumer assessment that the insoluble precipitates are non-volatile and will not contribute significantly to finished product odour.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A continuous in-line process for making a fragrance composition comprising the steps of:
(a) providing into a main line a pre-filtration solvent and a pre-filtration non-polar ingredient to form a pre-filtration solution;
(b) mixing the pre-filtration solution to form a mixed solution streaming through the main line;
(c) chilling the mixed solution to a temperature below 10° C. to provide a chilled solution containing precipitates; and
(d) filtering the chilled solution containing precipitates through a filter to remove the precipitates to provide a post-filtration solution streaming through the main line to make the fragrance composition.

2. The continuous in-line process of claim 1, wherein the chilling step is conducted at a chilling residence time from greater than 0 minutes to less than 25 minutes.

3. The continuous in-line process of claim 1, wherein chilling the mixed solution is to the temperature from 5° C. to −15° C.

4. The continuous in-line process of claim 1, wherein the chilling step is conducted at a chilling residence time of less than 20 minutes; and wherein chilling the mixed solution is to the temperature at or below 0° C.

5. The continuous in-line process of claim 4, wherein the chilling step is conducted at a chilling residence time of greater than 0 minutes to less than 10 minutes; and wherein chilling the mixed solution is to the temperature from 0° C. to −15° C.

6. The continuous in-line process of claim 1, wherein the pre-filtration non-polar ingredient comprises a perfume oil.

7. The continuous in-line process of claim 5, wherein the pre-filtration non-polar ingredient comprises a perfume oil.

8. The continuous in-line process of claim 1, wherein the pre-filtration solvent is provided into the main line at a rate from 0.1 L/min to 60 L/min, preferably from 0.9 L/min to 20 L/min

9. The continuous in-line process of claim 7, wherein the pre-filtration solvent is provided into the main line at a rate from 0.9 L/min to 20 L/min

10. The continuous in-line process of claim 1, wherein the pre-filtration solvent comprises an C₁-C₅ alcohol, even more preferably selected from the group consisting of methanol, and ethanol, preferably ethanol.

11. The continuous in-line process of claim 9, wherein the pre-filtration solvent comprises an organic solvent, wherein the organic solvent is selected from the group consisting of methanol, ethanol, and combinations thereof.

12. The continuous in-line process of claim 1, wherein the pre-filtration solvent comprises from 40% to 100% ethanol by weight of the pre-filtration solvent.

13. The continuous in-line process of claim 9, wherein the pre-filtration solvent comprises from 40% to 100% ethanol by weight of the pre-filtration solvent.

14. The continuous in-line process of claim 1, wherein the chilling step comprises the use of a heat exchanger configured to remove heat from mixed solution streaming through the main line.

15. The continuous in-line process of claim 1, further comprising the step of providing into the main line, upstream the chilling step, a UV absorber to provide the pre-filtration solution.

16. The continuous in-line process of claim 1, wherein the filter has a pore size having an average diameter of from 1 μm to 12 μm.

17. The continuous in-line process of claim 11, wherein the filter has a pore size having an average diameter from 1 μm to 5 μm.

18. The continuous in-line process of claim 1, comprising a further step of providing into the main line a post-filtration non-polar ingredient to the post-filtration solution (downstream the filter step (d)), wherein the post-filtration non-polar ingredient is selected from the group consisting of a dye, colorant, and combination thereof.

19. The continuous in-line process of claim 1, wherein the fragrance composition is free of any precipitates, and wherein the fragrance composition comprises: from 0.1 wt % to 40 wt % of a perfume oil; from 10 wt % to 90 wt % of ethanol, and one or more optional ingredients to the balance, wherein the wt % is relative to the total weight of the fragrance composition.

20. The continuous in-line process of claim 1, wherein:
(a) the pre-filtration non-polar ingredient comprises a perfume oil;
(b) the pre-filtration solvent comprises from 40% to 100% ethanol by weight of the pre-filtration solvent, and the pre-filtration solvent is provided into the main line at a rate from 0.9 L/min to 20 L/min;
(c) chilling the mixed solution to the temperature from 5° C. to −15° C. to provide a chilled solution containing precipitates, and wherein the step of reducing the temperature is conducted at a chilling residence time from greater than 0 minutes to less than 10 minutes;
(d) the filter having a pore size having an average diameter of from 1 μm to 10 μm to provide a filtered solution streaming through the main line;
(e) adding a post-filtration solvent into the main line to the filtered solution to make the fragrance composition, wherein the post-filtration solvent comprises ethanol;
(f) the fragrance composition comprises: from 0.1 wt % to 40 wt % of a perfume oil; from 10 wt % to 80 wt % of ethanol, and one or more optional ingredients to the balance, wherein the wt % is relative to the total weight of the fragrance composition.
